(19) United States
(12) Patent Application Publication
(10) Pub. No.: US 2009/0139091 A1
(43) Pub. Date: Jun. 4, 2009

(54) FIELD INSTALLATION OF A VEHICLE PROTECTION SYSTEM

(75) Inventors: Ricky G. Tucker, Woodstock, GA (US); Kevin Stramara, Chantilly, VA (US); Alan Cornett, Andover, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc,

(21) Appl. No.: 12/238,036

(22) Filed: Sep. 25, 2008

Related U.S. Application Data
(60) Provisional application No. 60/995,883, filed on Sep. 27, 2007.

(51) Int. Cl. B21D 53/88; B29C 65/00

(52) U.S. Cl. 29/897.2; 29/530; 89/36.01; 222/192; 264/46.5

(57) ABSTRACT

A method for armoring a vehicle by placing ballistic material inside a part of the vehicle and adding a foam material on the ballistic material that adheres to, and stabilizes, the ballistic material to form a lightweight armor, where the ballistic material and the foam material can absorb energy associated with projectile impact.

### CROSS REFERENCE TO RELATED APPLICATIONS

This application claims the benefit of U.S. Provisional Application No. 60/995,883, filed on Sep. 27, 2007, the contents of which are incorporated by reference herein.

### BACKGROUND

1. Field of the Invention

The disclosure generally relates to a unique field installation of a vehicle protection system. In particular, the disclosure pertains to a lightweight portable polyurethane and/or polyisocyanurate foam and ballistic resin material for use in vehicle armor to provide protection against various projectiles and to reduce or mitigate energy.

2. Discussion of the Related Art

Ease, time and materials are required to construct light-armored vehicles in field applications in a wide variety of field conditions and environments. Current construction methods and processes are not always available, acceptable or affordable in actual field applied environments. They can be time consuming, labor intensive, costly, material intensive, logistics restricted, transportation dependent, and require advanced planning.

Current technologies are factory manufactured and constructed, and are time and labor intensive. An example would be a factory-manufactured military vehicle. Other examples would be pre-manufacturing assemblies to be shipped to a secure and well-equipped location supported by power and specialized installers and tooling. In addition, it can take weeks to months to construct and ship operational ready vehicles or pre-assembled armored systems to an area where they are urgently needed.

The present disclosure provides numerous advantages over the conventional pre-manufactured armored system, such as being lightweight, portable, field applied, minimal training and equipment. In addition, the present disclosure is quick to construct, saving labor and dedicated assembly facilities that require power sources and staffing. The present disclosure provides a unique and easy way to assemble an armor plating system which is non-dependent upon the location and environment, therefore self-contained and sustainable in field applications.

The present disclosure also provides many additional advantages, which are described below.

### SUMMARY OF THE INVENTION

A system and method for providing armoring to a vehicle by placing ballistic material inside the body panel assembly of the vehicle, such as a door panel, roof, trunk, seat bottom, etc., and spraying or injecting a polyurethane and/or polyisocyanurate foam to adhere and stabilize the ballistic material therein are provided. Unexpectedly, the polyurethane and/or polyisocyanurate foam also assists in the absorption of energy associated with projectile impact.

The preferred foam material is a polyurethane and/or polyisocyanurate foam that is prepared with a blowing agent. The blowing agent can be, but is not limited to, water, carbon dioxide, methyl formate, a hydrocarbon, and/or a hydrofluorocarbon selected from the group consisting of 1,1,1,3,3-pentafluoropropane, 1,1,1,2-tetrafluoroethane, 1,1,2,2-tetrafluoroethane, 1,1,1,3,3-pentafluorobutane, 1,1,1,2,3,3,3-heptafluoropropane, and any combinations thereof. The foam material can be a closed-cell foam or an open-cell foam, or a combination thereof.

The preferred ballistic materials are high tenacity, high modulus filament and polyethylene protective yarns.

A preferred method of preparing a polyurethane and/or polyisocyanurate foam composition of the present disclosure comprises the step of reacting and foaming a mixture of ingredients which react to form polyurethane and/or polyisocyanurate foams in the presence of a blowing agent comprising a hydrofluorocarbon selected from the group consisting of 1,1,1,3,3-pentafluoropropane, 1,1,1,2-tetrafluoroethane, 1,1,2,2-tetrafluoroethane, 1,1,1,3,3-pentafluorobutane, 1,1,1,2,3,3,3-heptafluoropropane, and any combinations thereof; and an effective amount of a blowing agent additive (“additive”) selected from the group consisting of: α-methyl styrene, isobutanol, isopropanol and any combinations thereof. The additive is present in the amount of from about 0.02 to about 10 weight percent, based on the amount of blowing agent. A preferred embodiment has a blowing agent comprising 1,1,1,3,3-pentafluoropropane, and an additive comprising an effective amount of α-methyl styrene.

Another embodiment includes a closed cell polyurethane and/or polyisocyanurate foam prepared from a polymer foam formulation containing a blowing agent comprising one or more of: water, carbon dioxide, methyl formate, a hydrocarbon, and/or a hydrofluorocarbon selected from the group consisting of 1,1,1,3,3-pentafluoropropane, 1,1,1,2-tetrafluoroethane, 1,1,2,2-tetrafluoroethane, 1,1,1,3,3-pentafluorobutane, 1,1,1,2,3,3,3-heptafluoropropane, and any combinations thereof; and an effective amount of a blowing agent additive selected from the group consisting of: α-methyl styrene, isobutanol, isopropanol, and any combinations thereof. The blowing agent preferably comprises 1,1,1,3,3-pentafluoropropane and the additive comprises an effective amount of α-methyl styrene.

Optionally, the closed cell foam containing a cell gas comprises a blowing agent as defined above.

Further objects, features and advantages of the present disclosure will be understood by reference to the following drawings and detailed description.

### BRIEF DESCRIPTION OF THE DRAWINGS

FIGS. 1A-1D illustrate an exemplary method of the present disclosure, where ballistic material is inserted into a body panel of a vehicle, such as a door panel, and adding a foam material to the ballistic material to stabilize the ballistic material;

FIG. 2 illustrates a door panel of a vehicle armored by the present method that is being shot at close range with bullets of various calibers from Squad Automatic Weapons (SAW); and

FIG. 3 is a side view of a door panel of a vehicle armored by the present method illustrating that the bullets did not penetrate the door panel.

### DETAILED DESCRIPTION OF THE INVENTION

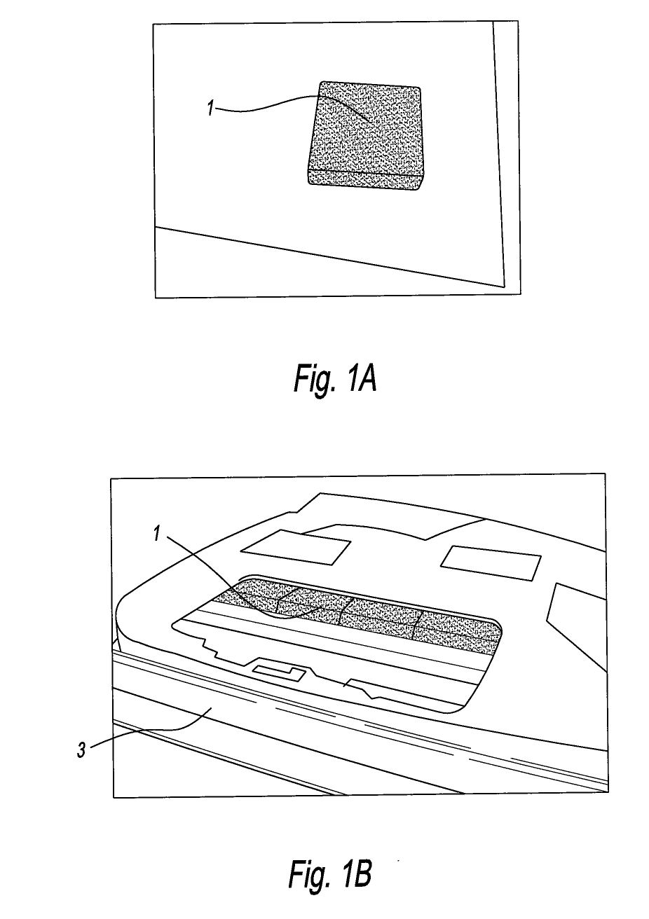

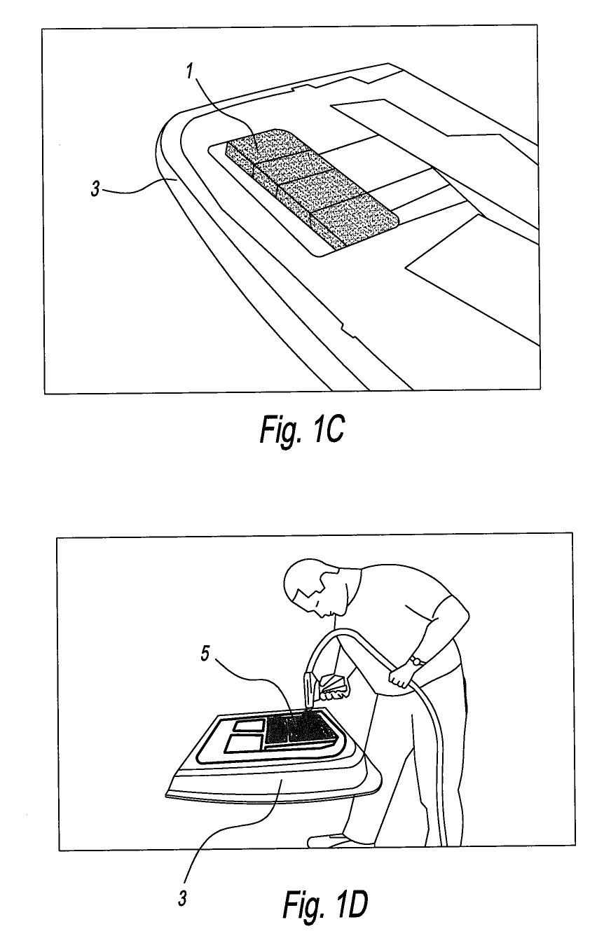

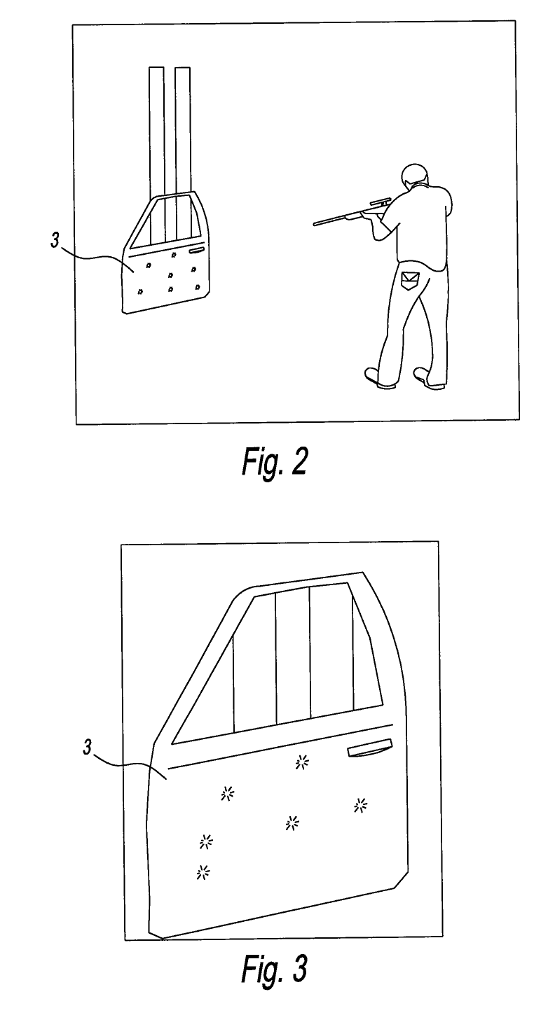

The present disclosure can best be described by referring to the figures. FIGS. 1A to 1D demonstrate the simple assembly steps required to install a ballistic material 1 inside of a door panel 3, wherein ballistic material 1 is stabilized within door panel 3 by injecting or spraying, or otherwise adding, a foam material 5 therein on the ballistic material 1. FIGS. 2 and 3 illustrate door panels 3 that are armored by the present method and are protected against projectiles (bullets).

Foam material 5 provides quick setting, strength, and durability. One preferred foam is recited in U.S. Pat. No. 6,545,063, “Hydrofluorocarbon blown foam and method for preparation thereof,” which is incorporated herein in its entirety.

The foam material is a polyurethane and/or polyisocyanurate foam. The foam material can include an additive such as α-methyl styrene, isobutanol and/or isopropanol, or combinations thereof, to reduce vapor pressure, improve k-factor, enhance the solubility of the blowing agent in the premix and improve the processing characteristics of polyurethane and polyisocyanurate foams. The polyurethane and/or polyisocyanurate foams are prepared with a blowing agent comprising one or more of the following: water, carbon dioxide, methyl formate, a hydrocarbon, and/or a hydrofluorocarbon selected from the group consisting of water, HCFC, HFC, low GWP HFC, 1,1,1,3,3-pentafluoropropane (HFC-245fa), 1,1,1,2-tetrafluoroethane (HFC-134a), 1,1,2,2-tetrafluoroethane (HFC-134), 1,1,1,3,3-pentafluorobutane (HFC-365mfc), 1,1,1,2,3,3,3-heptafluoropropane (HFC-227ea), and any combinations thereof.

A preferred foam material includes the addition of one or more blowing agent additives, including, but not limited to: α-methyl styrene, isobutanol, isopropanol, and any combinations thereof, to the B-side of a polyurethane and/or polyisocyanurate foam formulation, resulting in reduced vapor pressure, improved k-factor, enhanced solubility of the blowing agent and improved processing characteristics of the foam material. Addition of α-methyl styrene to the foam formulation results in improved thermal conductivity (k-factor) and thermal aging characteristics. With respect to thermal conductivity, the term “improved” refers to a decrease in the k-factor of the foam.

The polyurethane and/or polyisocyanurate foam composition is preferably prepared by reacting and foaming a mixture of ingredients which react to form a polyurethane and/or polyisocyanurate foam, in the presence of a blowing agent. The blowing agent comprises one or more of: water, carbon dioxide, methyl formate, a hydrocarbon, and/or a hydrofluorocarbon selected from the group consisting of 1,1,1,3,3-pentafluoropropane, 1,1,1,2-tetrafluoroethane, 1,1,2,2-tetrafluoroethane, 1,1,1,3,3-pentafluorobutane, 1,1,1,2,3,3,3-heptafluoropropane, and any combinations thereof. The reaction can also include a blowing agent additive that is one or more of the group consisting of: α-methyl styrene, isobutanol, isopropanol, and any combinations thereof. The blowing agent additive is present in an amount from about 0.02 to about 10 weight percent, based on the amount of blowing agent.

In a preferred embodiment, the method of preparing polyurethane and polyisocyanurate foam compositions comprises the step of reacting and foaming a mixture of ingredients which react to form polyurethane and/or polyisocyanurate foams in the presence of a blowing agent comprising 1,1,1,3,3-pentafluoropropane and an additive comprising α-methyl styrene. The amount of α-methyl styrene is present in an amount from about 0.02 to about 10 weight percent, and preferably in an amount from about 0.02 to about 5 weight percent, based on the amount of blowing agent.

A preferred closed cell polyurethane and/or polyisocyanurate foam is prepared from a polymer foam formulation containing as a blowing agent a hydrofluorocarbon selected from the group consisting of 1,1,1,3,3-pentafluoropropane, 1,1,1,2-tetrafluoroethane, 1,1,2,2-tetrafluoroethane, 1,1,1,3,3-pentafluorobutane, 1,1,1,2,3,3,3-heptafluoropropane, and any combinations thereof, and an effective amount of an additive selected from the group consisting of α-methyl styrene, isobutanol, isopropanol, and any combinations. Another preferred embodiment is a closed-cell polyurethane and/or polyisocyanurate foam prepared from a polymer foam formulation including a blowing agent comprising 1,1,1,3,3-pentafluoropropane and an additive comprising α-methyl styrene.

In another embodiment, a closed-cell polyurethane and/or polyisocyanurate foam contains a cell gas comprising a blowing agent that is one or more of water, carbon dioxide, methyl formate, a hydrocarbon, and/or a hydrofluorocarbon selected from the group consisting of 1,1,1,3,3-pentafluoropropane, 1,1,1,2-tetrafluoroethane, 1,1,2,2-tetrafluoroethane, 1,1,1,3,3-pentafluorobutane, 1,1,1,2,3,3,3-heptafluoropropane, and any combinations thereof; and an additive selected from the group consisting of: α-methyl styrene, isobutanol, isopropanol, and any combinations thereof, where the additive is preferably present in an amount from about 0.02 to about 10 weight percent, based on the amount of blowing agent. In one embodiment, the closed cell polyurethane and/or polyisocyanurate foam comprises a cell gas, a blowing agent comprising 1,1,1,3,3-pentafluoropropane and an additive comprising α-methyl styrene.

A preferred blowing agent composition comprises a hydrofluorocarbon selected from the group consisting of 1,1,1,3,3-pentafluoropropane, 1,1,1,2-tetrafluoroethane, 1,1,2,2-tetrafluoroethane, 1,1,1,3,3-pentafluorobutane, 1,1,1,2,3,3,3-heptafluoropropane, and any combinations thereof, and an additive selected from the group consisting of: α-methyl styrene, isobutanol, isopropanol, and any combinations thereof. More preferably, the blowing agent composition comprises 1,1,1,3,3-pentafluoropropane and α-methyl styrene, where the α-methyl styrene is preferably present in an effective amount, where the effective amount is from about 0.02 to about 5 weight percent, based on the amount of blowing agent.

As used herein, an effective amount of an additive means an amount, based on the amount of blowing agent, which reduces the vapor pressure of a foam formulation B-side to below the vapor pressure of the corresponding foam prepared in the absence of the additive. Generally, an effective amount of the additive is from about 0.02 to about 10 weight percent, based on the amount of blowing agent. Preferably, α-methyl styrene is added in an amount of from about 0.5 to about 2 weight percent, based on the amount of blowing agent.

As used herein, a blowing agent composition refers to HFC-245fa or HFC-134a singly or in combination with other non-ozone depleting blowing agents, such as, for example, other hydrofluorocarbons (including, but not limited to, difluoromethane (HFC-32), difluoroethane (HFC-152), trifluoroethane (HFC-143), tetrafluoroethane (HFC-134), pentafluoropropane (HFC-245), pentafluorobutane (HFC-365mfc), hexafluoropropane (HFC-236), heptafluoropropane (HFC-227)); C₄-C₇ hydrocarbons, including but not limited to butane, isobutane, n-pentane, isopentane, cyclopentane, hexane and isohexane; inert gases, including, but not limited to air, nitrogen, and carbon dioxide; and water; in an amount of from about 0.5 to about 2 parts per 100 parts of polyol. Where isomerism is possible for the hydrofluorocarbons mentioned above, the respective isomers may be used either singly or in the form of a mixture.

HFC-245fa is a known material and can be prepared by methods known in the art such as those disclosed in WO 94/14736, WO 94/29251, WO 94/29252 and U.S. Pat. No. 5,574,192. Difluoroethane, trifluoroethane, tetrafluoroethane, pentafluorobutane, heptafluoropropane and hexafluoropropane are available for purchase from Allied Signal Inc. of Morristown, N.J. Additives α-methyl styrene, isobutanol and isopropanol are also commercially available.

With respect to the preparation of rigid or flexible polyurethane or polyisocyanurate foams using a blowing agent comprising 1,1,1,3,3-pentafluoropropane or 1,1,1,2-tetrafluoroethane, any of the methods well known in the art can be employed. See Saunders and Frisch, Volumes I and II Polyurethanes Chemistry and Technology (1962). In general, polyurethane or polyisocyanurate foams are prepared by combining under suitable conditions an isocyanate (or isocyanurate), a polyol or mixture of polyols, a blowing agent or mixture of blowing agents, and other materials such as catalysts, surfactants, and optionally, flame retardants, colorants, or other additives.

It is convenient in many applications to provide the components for polyurethane or polyisocyanurate foams in pre-blended foam formulations. Most typically, the foam formulation is pre-blended into two components. The isocyanate or polyisocyanate composition comprises the first component, commonly referred to as the “A” component or “A-side.” The polyol or polyol mixture, surfactant, catalysts, blowing agents, flame retardant, water and other isocyanate reactive components comprise the second component, commonly referred to as the “B” component or “B-side.” While the surfactant and fluorocarbon blowing agent are usually placed on the polyol side, they may be placed on either side, or partly on one side and partly on the other side. Accordingly, polyurethane or polyisocyanurate foams are readily prepared by bringing together the A and B side components either by hand mix, for small preparations, or preferably machine mix techniques to form blocks, slabs, laminates, pour-in-place panels and other items, spray applied foams, froths, and the like. Optionally, other ingredients such as fire retardants, colorants, auxiliary blowing agents, water and even other polyols can be added as a third stream to the mix head or reaction site. Most conveniently, however, they are all incorporated into one B component.

The α-methyl styrene, isobutanol and isopropanol additives of the present invention may be added to B-side of the foam formulation, or to the blowing agent per se, by any manner well known in the art.

Any organic polyisocyanate can be employed in polyurethane or polyisocyanurate foam synthesis inclusive of aliphatic and aromatic polyisocyanates. Preferred as a class are the aromatic polyisocyanates. Preferred polyisocyanates for rigid polyurethane or polyisocyanurate foam synthesis are the polymethylene polyphenyl isocyanates, particularly the mixtures containing from about 30 to about 85 percent by weight of methylenebis(phenylisocyanate) with the remainder of the mixture comprising the polymethylene polyphenyl polyisocyanates of functionality higher than 2. Preferred polyisocyanates for flexible polyurethane foam synthesis are toluene diisocyanates including, without limitation, 2,4-toluene diisocyanate, 2,6-toluene diisocyanate, and mixtures thereof.

Typical polyols used in the manufacture of rigid polyurethane foams include, but are not limited to, aromatic amino-based polyether polyols such as those based on mixtures of 2,4- and 2,6-toluenediamine condensed with ethylene oxide and/or propylene oxide. These polyols find utility in pour-in-place molded foams. Another example is aromatic alkylamino-based polyether polyols such as those based on ethoxylated and/or propoxylated aminoethylated nonylphenol derivatives. These polyols generally find utility in spray applied polyurethane foams. Another example is sucrose-based polyols such as those based on sucrose derivatives and/or mixtures of sucrose and glycerine derivatives condensed with ethylene oxide and/or propylene oxide. These polyols generally find utility in pour-in-place molded foams.

Typical polyols used in the manufacture of flexible polyurethane foams include, but are not limited to, those based on glycerol, ethylene glycol, trimethylolpropane, ethylene diamine, pentaerythritol, and the like condensed with ethylene oxide, propylene oxide, butylene oxide, and the like. These are generally referred to as “polyether polyols.” Another example is the graft copolymer polyols which include, but are not limited to, conventional polyether polyols with vinyl polymer grafted the polyether polyol chain. Yet another example is polyurea modified polyols which consist of conventional polyether polyols with polyurea particles dispersed in the polyol.

Examples of polyols used in polyurethane modified polyisocyanurate foams include, but are not limited to, aromatic polyester polyols such as those based on complex mixtures of phthalate-type or terephthalate-type esters formed from polyols such as ethylene glycol, diethylene glycol, or propylene glycol. These polyols are used in rigid laminated boardstock, and may be blended with other types of polyols such as sucrose based polyols, and used in polyurethane foam applications.

Catalysts used in the manufacture of polyurethane foams are typically tertiary amines including, but not limited to, N-alkylmorpholines, N-alkylalkanolamines, N,N-dialkylcyclohexylamines, and alkylamines where the alkyl groups are methyl, ethyl, propyl, butyl and the like and isomeric forms thereof, as well as heterocyclic amines. Typical, but not limiting, examples are triethylenediamine, tetramethylethylenediamine, bis(2-dimethylaminoethyl)ether, triethylamine, tripropylamine, tributylamine, triamylamine, pyridine, quinoline, dimethylpiperazine, piperazine, N,N-dimethylcyclohexylamine, N-ethylmorpholine, 2-methylpiperazine, N,N-dimethylethanolamine, tetramethylpropanediamine, methyltriethylenediamine, and mixtures thereof.

Optionally, non-amine polyurethane catalysts are used. Typical of such catalysts are organometallic compounds of lead, tin, titanium, antimony, cobalt, aluminum, mercury, zinc, nickel, copper, manganese, zirconium, and mixtures thereof. Exemplary catalysts include, without limitation, lead 2-ethylhexoate, lead benzoate, ferric chloride, antimony trichloride, and antimony glycolate. A preferred organo-tin class includes the stannous salts of carboxylic acids such as stannous octoate, stannous 2-ethylhexoate, stannous laurate, and the like, as well as dialkyl tin salts of carboxylic acids such as dibutyl tin diacetate, dibutyl tin dilaurate, dioctyl tin diacetate, and the like.

In the preparation of polyurethane or polyisocyanurate foams, trimerization catalysts are used for the purpose of converting the blends in conjunction with excess A component to polyisocyanurate-polyurethane foams. The trimerization catalysts employed can be any catalyst known to one skilled in the art including, but not limited to, glycine salts and tertiary amine trimerization catalysts, alkali metal carboxylic acid salts, and mixtures thereof. Preferred species within the classes are potassium acetate, potassium octoate, and N-(2-hydroxy-5-nonylphenol)methyl-N-methylglycinate.

Also included in the mixture are blowing agents or blowing agent blends. Generally speaking, the amount of blowing agent present in the blended mixture is dictated by the desired foam densities of the final polyurethane or polyisocyanurate foams products. The polyurethane foams produced can vary in density, for example, from about 0.5 pound per cubic foot to about 40 pounds per cubic foot, preferably from about 1 to about 20 pounds per cubic foot, and most preferably from about 1 to about 6 pounds per cubic foot. The density obtained is a function of how much of the blowing agent, or blowing agent mixture, is present in the A and/or B components, or that is added at the time the foam is prepared. The proportions in parts by weight of the total blowing agent or blowing agent blend can fall within the range of from 1 to about 60 parts of blowing agent per 100 parts of polyol. Preferably from about 10 to about 35 parts by weight of blowing agent per 100 parts by weight of polyol are used.

Dispersing agents, cell stabilizers, and surfactants may be incorporated into the blowing agent mixture. Surfactants, better known as silicone oils, are added to serve as cell stabilizers. Some representative materials are sold under the names of DC-193, B-8404, and L-5340 which are, generally, polysiloxane polyoxyalkylene block co-polymers such as those disclosed in U.S. Pat. Nos. 2,834,748, 2,917,480, and 2,846,458.

Other optional additives for the blowing agent mixture may include flame retardants such as tris(2-chloroethyl)phosphate, tris(2-chloropropyl)phosphate, tris(2,3-dibromopropyl)phosphate, tris(1,3-dichloropropyl)phosphate, diammonium phosphate, various halogenated aromatic compounds, antimony oxide, aluminum trihydrate, polyvinyl chloride, and the like.

Preferred ballistic materials are, for example, those disclosed in U.S. Patent Application Publication Nos. US 2006/0035078 and US 2004/0258909, and U.S. Pat. No. 6,746,975, all of which are incorporated herein in the entirety by reference thereto.

For example, one ballistic material comprises high strength, high tensile modulus polyethylene yarn having a coherence and roundness suitable for weaving into a protective fabric and which flattens and spreads out when the fabric is scoured. The untwisted polyethylene yarn comprising a plurality of filaments in essentially parallel array and from about 0.5 to 5 weight percent of a water-dispersible binder material covering less than half the surfaces of said filaments. The yarn has a tenacity greater than about 17 g/d, a tensile modulus greater than about 300 g/d, fewer than about 20 entanglements/meter in a scoured state and has a width satisfying the following formula W≦0.055 √d where W is the yarn width in millimeters under a tensile load of 0.01 grams per denier measured on a flat surface, and d is the yarn denier. The requirement for the yarn width expressed by this formula insures sufficient yarn roundness for good weaving. Preferably, the yarn width (W) satisfies the following formula W≦0.055 √d where W is the yarn width in millimeters under a tensile load of 0.01 grams per denier measured on a flat surface, and d is the yarn denier. The woven fabric is especially useful in applications requiring ballistic-resistance and/or cut resistance, more preferably the former.

When the yarn has some degree of twist, the yarn width W is measured along a yarn length at least twice the twist periodicity, and is the maximum (as opposed to average) measurement taken along this length.

The number of entanglements per meter is measured after scouring the yarn to remove the binding material. “Entanglements” are interlocked filaments that cannot be readily separated. Entanglements may be formed during the process of spinning multiple filaments. The number of entanglements/meter is measured by the method of ASTM D4724-99, with the modification that the apparatus used is the Model HW70735 Interlace Tester manufactured by Industrial Machine Works, Waynesboro, Va. Preferably, the yarn of the invention has fewer than about 10 entanglements/meter in the scoured state.

The percentage of the filament surfaces that are covered by the water-dispersible binder material is determined using a microscope with digital image analysis software, such as IMAGE-PRO® software from Media Cybernetics, Silver Spring, Md. To aid in the measurement, the binder material may be selectively dyed to enhance contrast by using a water-soluble dye that is not absorbed by polyethylene.

The water-dispersible binder material is preferably selected from the group consisting of: a salt of an acrylic copolymer, sodium carboxymethyl cellulose, polyethylene oxide, polypropylene oxide, ethylene oxide/propylene oxide copolymers, polyvinyl alcohol, modified starch, esterified starch, cationic starch, starch-styrene/butadiene copolymer, and mixtures thereof. Preferably, the water-dispersible binder forms about 0.5 to about 3 wt % of the yarn of the invention. It will be understood that the terms “weight percent” or “wt %” have the conventional meaning of weight of binder per weight of filaments plus binder.

The untwisted yarn of the invention is produced by an improvement to a process for the preparation of polyethylene yarns having a plurality of filaments in essentially parallel array, a tenacity greater than about 17 g/d, a tensile modulus greater than about 300 g/d and fewer than about 20 entanglements/meter in a scoured state. The improvement comprises the application of about 0.5 to 5 wt % of a water-dispersible binder material so as to cover less than half the surfaces of said filaments during a last drawing step under a tension of greater than about 2 grams/denier, more preferably under a tension of greater than about 3 grams/denier. Preferably, the last drawing step is at an elevated temperature between about 110° C. and about 160° C.

Surprisingly, the application of the binder material when the yarn is under substantial tension is believed to be a key factor in achieving superior ballistic effectiveness in fabric woven from the yarn. Without being held to a particular theory of why the invention works, it is believed that application of the binder material when the yarn is under substantial tension prevents complete wetting of the surfaces of the filaments. The binder forms limited area binding points between filaments sufficient to provide cohesion to the yarn for weaving, but not sufficient to reduce ballistic effectiveness. Moreover, the limited area binding points are more readily removed by scouring to achieve maximum ballistic effectiveness.

An untwisted polyethylene yarn having a plurality of essentially parallel filaments, a tenacity greater than about 17 g/d, a tensile modulus greater than about 300 g/d and fewer than about 20 entanglements/meter is preferably produced by any of the processes described by U.S. Pat. Nos. 4,413,110, 4,551,296, 4,663,101, and 6,448,359, all incorporated herein by reference to the extent not incompatible herewith.

Preferably the yarn of the invention is produced by an improvement to the process of U.S. Pat. No. 5,741,451, incorporated herein by reference to the extent not incompatible herewith. This process comprises the preparation of a very low creep, ultra high modulus, low shrink, high tenacity polyethylene multiple filament yarn by: a) drawing a high molecular weight polyethylene yarn at a temperature within 10° C. of its melting temperature to form a drawn, highly oriented polyethylene yarn; b) then poststretching the yarn at a drawing rate of less than about 1 second⁻¹ at a temperature within 10° C. of its melting temperature, and cooling said yarn under tension sufficient to retain its highly oriented state. The improvement comprises applying to the yarn about 0.5 to 5 wt % of a water-dispersible binder material so as to cover less than half the surfaces of the filaments during one of drawing step a) or poststretching step b) under a tension greater than about 2 grams/denier.

The protective woven fabric of the disclosure, preferably ballistic-resistant, comprises in majority portion an untwisted polyethylene yarn comprising: a plurality of filaments in essentially parallel array and about 0.5 to 5 wt % of a water-dispersible binder material covering less than half the surfaces of said filaments. The yarn has a tenacity greater than about 17 g/d and a tensile modulus (modulus of elasticity) greater than about 300 g/d as measured by ASTM D2256, fewer than 20 entanglements/meter in the scoured state and a width satisfying the following formula W≦0.055 √d, where W is the yarn width in millimeters under a tensile load of 0.01 grams per denier measured on a flat surface, and d is the yarn denier.

The woven fabric of the invention may be plain woven, basket woven, satin or crowfeet woven or any other standard weave. It is preferred that the yarns in the fabric have as few out-of-plane bends as possible. An eight-harness satin weave is particularly preferred.

It is also preferred that the fabrics of the invention are scoured and/or calendered to flatten and spread the yarns, thereby enhancing their ballistic resistance. It is most preferred that the fabrics of the invention are both scoured and calendered, with calendering preferably occurring after scouring.

The ballistic-resistant woven fabric of the invention possesses at least 5% greater specific energy absorption when impacted with a 9 mm FMJ bullet at its V50 velocity than a woven fabric having the same construction using polyethylene yarns having the same tenacity and tensile modulus but having more than 20 entanglements/meter and/or greater twist.

Still yet another ballistic material according to the present disclosure includes a high tenacity, high modulus yarn. The polymer used in forming this yarn is crystallizable polyethylene. By the term “crystallizable” is meant a polymer which exhibits an x-ray diffraction pattern ascribable to a partially crystalline material.

A method of preparing such high tenacity, high modulus multi-filament yarns includes extruding a solution of polyethylene and solvent where the polyethylene has an intrinsic viscosity (measured in decalin at 135° C.) between about 4 dl/g and 40 dl/g through a multi-orifice spinneret into a cross-flow gas stream to form a multi-filament fluid product. The multi-filament fluid product is stretched, above the temperature at which a gel will form, and at a stretch ratio of at least 5:1, over a length less than about 25 mm with a cross-flow gas stream velocity of less than about 3 m/min. The fluid product is quenched in a quench bath consisting of an immiscible liquid to form a gel product. The gel product is stretched. The solvent is removed from the gel product to form a xerogel product substantially free of solvent. The xerogel product is stretched where the total stretch ratio is sufficient to product a polyethylene article having a tenacity of at least 35 g/d, a modulus of at least 1600 g/d, and a work-to-break of at least 65 J/g.

The term “xerogel” is derived by analogy to silica gel and as used herein means a solid matrix corresponding to the solid matrix of a wet gel with the liquid replaced by a gas (e.g., by an inert gas such as nitrogen or by air) This is formed when the second solvent is removed by drying under conditions that leaves the solid network of the polymer substantially intact.

Such yarns and films have a unique and novel microstructure characterized by a high strain orthorhombic crystalline component comprising more than about 60% of the orthorhombic crystalline component and/or a monoclinic crystalline component exceeding 2% of the crystalline content. As will be discussed in the examples below, such yarns are exceptionally efficient in absorbing the energy of a projectile in an anti-ballistic composite. It will be understood that a “yarn” is defined as an elongated body comprising multiple individual filaments having cross-sectional dimensions very much smaller than their length. It will be further understood that the term yarn does not imply any restriction on the shapes of the filaments comprising the yarn or any restriction on the manner in which the filaments are incorporated in the yarn. The individual filaments may be of geometric cross-sections or irregular in shape, entangled or lying parallel to one another within the yarn. The yarn may be twisted or otherwise depart from a linear configuration.

The polyethylene used in the process of this invention has an intrinsic viscosity (IV) (measured in decalin at 135° C.) between about 4 and 40 dl/g. Preferable, the polyethylene has an IV between 12 and 30 dl/g.

The polyethylene may be made by several commercial processes such as the Zeigler process and may contain a small amount of side branches such as produced by incorporation of another alpha olefin such as propylene or 1-hexene. Preferably, the number of side branches as measured by the number of methyl groups per 1000 carbon atoms, is less than about 2. More preferably, the number of side branches is less than about 1 per 1000 carbon atoms. Most preferably the number of side branches is less than about 0.5 per 1000 carbon atoms. The polyethylene may also contain minor amounts, less than 10 wt % and preferably less than 5 wt %, of flow promoters, anti-oxidants, UV stabilizers and the like.

The solvent for the polyethylene used in this invention should be non-volatile under the spinning conditions. A preferred polyethylene solvent is a fully saturated white mineral oil with an initial boiling point exceeding 350° C., although other, lower boiling solvents such as decahydronaphthalene (decalin) may be used.

While we have shown and described several embodiments in accordance with my invention, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A method for armoring a vehicle comprising:
placing a ballistic material in a body panel in the vehicle; and
adding a foam material on said ballistic material in said body panel in the vehicle,
wherein said foam material adheres to said ballistic material and stabilizes said ballistic material to form a lightweight armor,
wherein said ballistic material absorbs energy associated with ballistic impact in the vehicle; and
wherein said foam material further assists in absorption of energy associated with ballistic impact in the vehicle.

2. The method according to claim 1, wherein said ballistic material comprises a material selected from the group consisting of: polyethylene yarn, high-tenacity-high-modulus filament, ballistic resin material, and any combinations thereof.

3. The method according to claim 1, wherein said ballistic material comprises an untwisted polyethylene yarn.

4. The method according to claim 1, further comprising applying a binder material when said ballistic material is under substantial tension.

5. The method according to claim 4, wherein said binder material is selected from the group consisting of: a salt of an acrylic copolymer, sodium carboxymethyl cellulose, polyethylene oxide, polypropylene oxide, ethylene oxide/propylene oxide copolymers, polyvinyl alcohol, modified starch, esterified starch, cationic starch, starch-styrene/butadiene copolymer, and any combinations thereof.

6. The method according to claim 1, wherein said ballistic material comprises a protective fabric of polyethylene yarn that is woven, and scoured and/or calendared.

7. The method according to claim 1, wherein said body panel of the vehicle comprises a vehicle part that is selected from the group consisting of: a door panel, roof, trunk, seat bottom, and any combinations thereof.

8. The method according to claim 1, wherein said foam material is lightweight and portable, and
wherein said foam material can be applied on-site to said ballistic material.

9. The method according to claim 1, wherein said foam material cures rapidly on said ballistic material to form said lightweight armor.

10. The method according to claim 1, wherein said foam material comprises a closed-cell foam.

11. The method according to claim 1, wherein said foam material is selected from the group consisting of: polyurethane foam, polyisocyanurate foam, and combinations thereof.

12. The method according to claim 11, wherein said foam material further comprises:
a blowing agent selected from the group consisting of: water, carbon dioxide, methyl formate, hydrocarbon, hydrochlorofluorocarbon (HCFC), hydrofluorocarbon (HFC), low Global Warming Potential hydrofluorocarbon (low GWP HFC), and any combinations thereof; and
a blowing agent additive selected from the group consisting of: α-methyl styrene, isobutanol, and isopropanol, and any combinations thereof,
wherein said blowing agent and said blowing agent additive contact a mixture of ingredients which react to form said polyurethane foam and/or polyisocyanurate foam.

13. The method according to claim 12, wherein said hydrofluorocarbon is selected from the group consisting of: 1,1,1,3,3-pentafluoropropane (HFC-245fa), 1,1,1,2-tetrafluoroethane (HFC-134a), 1,1,2,2-tetrafluoroethane (HFC-134), 1,1,1,3,3-pentafluorobutane (HFC-365mfc), 1,1,1,2,3,3,3-heptafluoropropane (HFC-227ea), and any combinations thereof.

14. The method according to claim 12, wherein said blowing agent additive is present in an amount of from about 0.02 to about 10 weight percent, based on a total amount of said blowing agent.

15. The method according to claim 12, wherein said blowing agent comprises 1,1,1,3,3-pentafluoropropane (HFC-245fa), and said blowing agent additive comprises α-methyl styrene; and
wherein said α-methyl styrene is present in an amount of from about 0.02 to about 10 weight percent, based on a total amount of said 1,1,1,3,3-pentafluoropropane (HFC-245fa).

16. The method according to claim 12, wherein said polyurethane foam and/or polyisocyanurate foam comprises a pre-blended foam formulation, wherein said pre-blended foam formulation comprises:
a first component that is an “A-side” component; and
a second component that is a “B-side” component,
wherein said blowing agent is incorporated in said first component (“A-side”) and/or said second component (“B-side”), and
wherein said polyurethane foam and/or polyisocyanurate foam are prepared by mixing said first component (“A-side”) and said second component (“B-side”), and added on said ballistic material.

17. A kit for armoring a vehicle, comprising:
a ballistic material;
a foam material system comprising one or more containers and a dispensing apparatus,
wherein said one or more containers contain one or more compositions that are dispensed through said dispensing apparatus and form a foam material that adheres to said ballistic material to form a lightweight armor.

18. The kit according to claim 17, wherein said foam material is selected from the group consisting of: polyurethane foam, polyisocyanurate foam, and combinations thereof.

19. The kit according to claim 17, wherein the dispensing apparatus is a spray nozzle.
